(19) United States
(12) Patent Application Publication
(10) Pub. No.: US 2010/0265597 A1
(43) Pub. Date: Oct. 21, 2010

(54) RECTANGULAR STACKED GLASS LENS MODULE WITH ALIGNMENT MEMBER AND MANUFACTURING METHOD THEREOF

(76) Inventor: San-Woei SHYU, Taipei (TW)

Correspondence Address: Muncy, Geissler, Olds & Lowe, PLLC, 4000 Legato Road, Suite 310, FAIRFAX, VA, 22033, US

(21) Appl. No.: 12/759,209

(22) Filed: Apr. 13, 2010

(30) Foreign Application Priority Data
Apr. 15, 2009 (TW) 098112490

(51) Int. Cl. G02B 9/00; C03B 23/22

(52) U.S. Cl. 359/797; 65/37

(57) ABSTRACT

A rectangular stacked lens module and a manufacturing method thereof are disclosed. The rectangular stacked lens module is produced by cutting straight lines through a stacked lens module array. Firstly, it produces at least two lens arrays. Each lens array includes a plurality of optical lenses by multi-cavity glass molding and at least one alignment member disposed on the non-optical area of the lens array. Then at least the two lens arrays are assembled by the alignment members and are stacked with other optical elements so as to form a stacked lens module array. The optical axis of each optical lens is aligned easily with each other so as to meet requirements for optical precision. Moreover, the manufacturing processes are simplified and the purposes of mass-production and low cost are achieved.

### BACKGROUND OF THE INVENTION

The present invention relates to a stacked glass lens module with alignment member and a manufacturing method thereof, especially to a rectangular stacked glass lens module with alignment member and a manufacturing method thereof that are applied to assembled lenses of light emitting diode (LED) light sources, assembled lenses of solar energy conversion systems and optical lenses of cameras and phone cameras.

Glass precision molding technology has been widely applied to manufacture aspherical molded glass lens with high resolution, good stability and low cost such as lens revealed in US2006/0107695, US2007/0043463, TW095101830, TW095133807, and JP63-295448 etc. A glass preform is set into a mold having an upper mold and a lower mold to be heated and softening. Then the upper mold and the lower mold are assembled correspondingly and apply pressure on the upper mold and the lower mold so as to make the soft glass perform have the same optical surfaces as that of the upper mold and the lower mold. After cooling, a molded glass lens with mold surfaces of the upper mold and the lower mold is released. In order to reduce manufacturing cost, prior arts—JP63-304201 and US2005/041215 reveal a lens array formed by glass molding. As to a single lens-called a lens element hereunder, JP02-044033 revealed that a lens blank having a plurality of lenses is manufactured by movement of glass materials and multiple molding ways. Then the lens blank is cut into a plurality of lens elements.

The optical lens formed by glass molding is widely applied to assembled lenses of LED light sources, lenses of solar energy conversion systems, and optical lenses of mobile phone cameras. The assembled lens or optical lens is formed by a plurality of optical lenses with different lens power assembled with other optical elements such as a shade, an infrared (IR)-cut lens, an aperture, an image capture device (ICD) or photo-electronic device (PED) arranged at a certain interval between one another. Thus while assembling, an optical axis of each optical lens must be aligned precisely so as to avoid the reduction of resolution. Moreover, the distance between two adjacent optical lenses (interval) is fixed. Thus the assembling requires a plurality of processes and precise correction. Therefore, the yield rate is unable to increase and the cost reduction is difficult.

For mass production, the manufacturing of the optical lens array has received more attention. As to the manufacturing of the optical lens array, JP2001194508 discloses a manufacturing method of plastic optical lens array. Taiwanese patent No. M343166 reveals a manufacturing method of glass optical lens array. In manufacturing of arrayed optical lens modules, wafer level lens modules are revealed in U.S. Pat. No. 7,183,643, US2007/0070511, WO2008011003, WO2008094499 and so on. Refer to FIG. 1, a tri-piece arrayed optical lens module 70 generally includes an aperture 701, a cover glass 702, a plurality of optical lenses and an infrared (IR) cut lens 717. As shown in figure, the plurality of optical lenses forms a three piece type optical lens set having a first optical lens 704, a second optical lens 705 and a third optical lens 706 and an IR cut lens 707. Two adjacent optical lenses are separated by a spacer 713. After being assembled, a lens module array 70 is formed.

However, in a lens module array, while assembling a lens array with plurality of optical lenses, the alignment of the lens array has effects on resolution of the lens module. In US20060249859, imaging techniques are used to determine if stacked wafers are in proper alignment. Fiducial marks that were previously patterned on each wafer of the stack are exposed in an image produced by the captured infrared radiation. The degree of alignment of the wafers can be measured using the fiducial marks exposed in the image. In assembling of plastic optical lens arrays, JP2000-321526 and JP2000-227505 revealed bi-convex type optical lens arrays formed by combination of heights with crevices. As to U.S. Pat. No. 7,187,501, cone-shaped projections are used to form a resin lens array by stacking the resin lenses one over another. Refer to US2008/0007623, a camera module having an array with multiple colors is revealed. As shown in FIG. 2, a wafer scale camera device is disclosed in 2006/0044450. A substrate 711 is arranged with a first lens array and a second lens array 712, 713 respectively, separated by a spacer substrate 714 to form a lens module array 71. Then cut the lens array 71 to get a lens module 72. Refer to FIG. 3, as shown in WO2008094499, two lenses 731, 732, and an image capture device (ICD) 733 are disposed on a circuit board 735 by glue 734 to form a lens module 73. The lens arrays or lens modules shown from FIG. 1 to FIG. 3 still got problems in alignment of optical axes of the lenses. Thus the improvement of resolution is difficult to achieve.

As to the lens module used in cameras and phone cameras, it generally includes a plurality of lens with various concave or convex optical surfaces. Such lens modules have higher requirements of the alignment of the optical axis, and the location precision of optical surfaces. In the conventional assembling way of projections and holes to form plastic optical lens array, material shrinkage after the plastic injection molding will lead to size change of the projections and the holes. Thus the location precision is affected and the alignment of the optical axis is difficult. Therefore, the applications of the plastic optical lens array is limited, especially during manufacturing of small-size lens module, the complicated processes cause cost increase. The molded glass has better reflective index than the plastic and also with better thermostability so that the molded glass has been applied to various optical systems. Moreover, the optical lens array made from molded glass exhibit less shrinkage.

Thus there is a need to develop a method of manufacturing stacked optical glass lens arrays as well as stacked lens modules with simple structure and high precision so as to provide stacked lens modules for assembled lenses of light emitting diode (LED) light sources, assembled lenses of solar energy conversion systems and optical lenses of phone cameras. And the lens modules meet requirements of mass-production and yield rate.

### SUMMARY OF THE INVENTION

Therefore it is a primary object of the present invention to provide a rectangular stacked glass lens module with alignment member and a manufacturing method thereof in which the stacked glass lens module is formed by making straight cuts through the stacked lens module array. Each rectangular stacked glass lens module includes at least two optical glass lenses that are assembled with other optical elements at a preset interval. The stacked optical glass lens module array includes at least two optical glass lens arrays that are produced by multi-cavity glass molding and are disposed with a plurality of lenses arranged in an array. An alignment member is arranged at a periphery of a non-optical surface of the optical glass lens arrays. The alignment members of two adjacent lens arrays are connected and assembled with each other so as to make each lens thereof align the optical axis.

It is another object of the present invention to provide a rectangular stacked glass lens module with alignment member and a manufacturing method thereof in which an alignment member is designed as a through hole for convenience of assembly when the stacked lens module array consists of a plurality of optical elements. The through hole is arranged at a non-optical surface of each lens array and a proper position of each optical element. While assembling, the through-hole of the lens array and the through hole of the optical element are positioned over a rod of a jig assembly so as to align the lens array and the optical elements. Thus convenient and precise assembling is achieved.

In accordance with the above manufacturing method, a stacked lens module array is produced one at a time. Then the stacked lens module array is cut into a plurality of rectangular stacked lens modules. Thus the purposes of precise assembling and mass production are achieved.

### BRIEF DESCRIPTION OF THE DRAWINGS

FIGS. 1 to 3 are schematic drawings showing a conventional optical glass lens array or lens module;

FIG. 4 is a flow chart showing manufacturing process of an embodiment according to the present invention;

FIG. 5 is a cross sectional view of an embodiment of a lens module array and an embodiment of a lens module after being cut;

FIG. 6 is a cross sectional view of an embodiment of a lens module array having a conical alignment member;

FIG. 7 is a cross sectional view sowing assembling of through-hole fixtures in a second embodiment of a lens module array according to the present invention;

FIG. 8 is a flow chart showing manufacturing process of an embodiment of a lens module array with through-hole alignment member;

FIG. 9 is a cross sectional view of an embodiment of a lens module array and a first embodiment of a lens module after being cut;

FIG. 10 is a cross sectional view of a third embodiment of a lens module according to the present invention;

FIG. 11 is a cross sectional view of a fourth embodiment of a lens module according to the present invention;

FIG. 12 is a cross sectional view of a fifth embodiment of a lens module according to the present invention;

FIG. 13 is a cross sectional view of a sixth embodiment of a lens module according to the present invention.

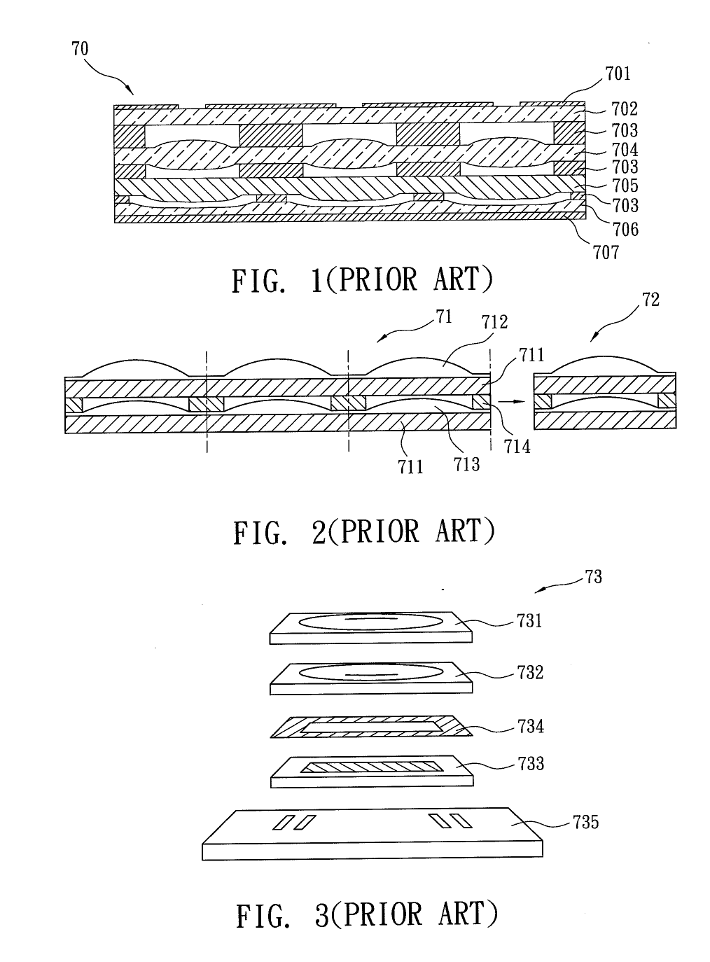

### DETAILED DESCRIPTION OF THE PREFERRED EMBODIMENT

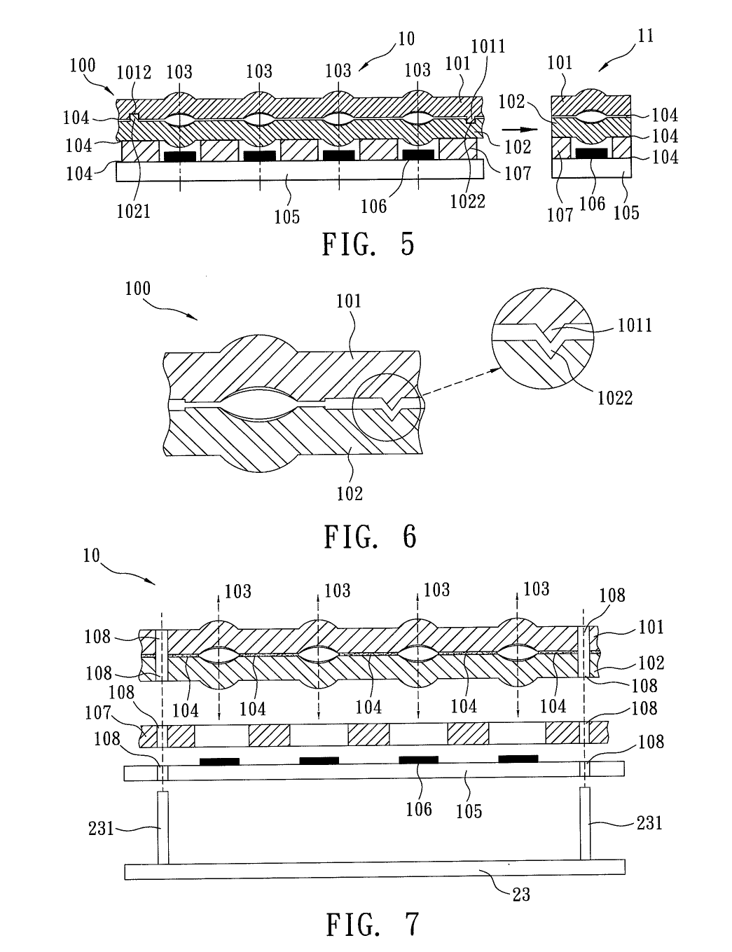

Refer to FIG. 5, an alignment member such as an alignment pin 1011 or an alignment cavity 1022 is arranged on a periphery of a non-optical surface of a first (optical glass) lens array 101. A corresponding alignment member such as an alignment cavity 1022 or an alignment pin 1011 is disposed on a periphery of a non-optical surface of an adjacent second lens array 102. The alignment member is molded together with the two lens arrays 101, 102 so that each alignment member and an optical axis 103 are fixed. After the first and the second lens arrays 101, 102 are assembled correspondingly, the optical axes 103 of each lens are aligned and then are fixed by glue 104 so as to form a lens module array 100 precisely. The other optical elements are stacked thereof. In FIG. 5, the optical elements of this embodiment includes an optical element 105 such as a circuit board, a plurality of optical elements 106 such as image sensors and a plurality of optical elements 107 with a preset thickness such as spacers for separating the lens module array 100 and the optical elements 106. Next the lens module array 100 and the optical element 105 are attached with each other by glue 104. After curing, a stacked lens module array 10 is produced. Then make straight cuts, a plurality of rectangular stacked lens modules 11 is generated.

The alignment member includes a plurality of alignment pins 1011/1021 and a plurality of corresponding alignment cavities 1022/1012 assembled with each other. The shape of the alignment pins 1011/1021 is not limited and it can be a column, a rectangular prism or a cone, as shown in FIG. 6 while the shape of the corresponding alignment cavities 1022/1012 is a columnar or conical receiving hole, corresponding to that of the alignment pins 1011/1021.

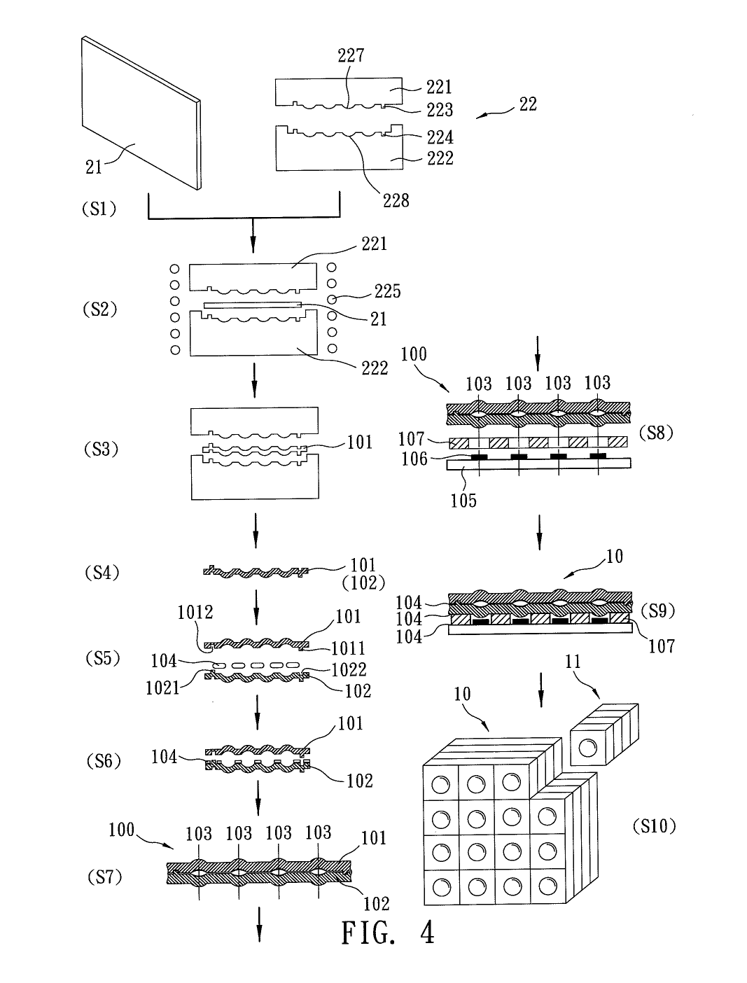

Refer to FIG. 4, a manufacturing method of the rectangular stacked lens module 11 includes following steps:
S1: providing a rectangular sheet-like glass blank 21 and a molding mold 22 having an upper mold 221 and a lower mold 222 respectively disposed with a mold core of multi-cavity optical surfaces 227/228 and a mold pin/mold bushing 223. 224;
S2: setting the glass blank 21 into the mold 22, then heat the glass blank 21 by a heater 225 and apply pressure to run molding processes;
S3: molding a lens array 101 with alignment members such as alignment pins and alignment cavities; as shown in FIG. 4, there are 16 lenses arranged in an array;
S4: producing another lens array 102 according to the above steps from S1 to S3 and the two adjacent lens arrays 101, 102 have corresponding alignment members such as alignment cavities 1022/1012 and alignment pins 1011/1021;
S5: coating ultraviolet (UV) curing glue 104 on a non-optical area between the two adjacent optical glass lenses 101, 102;
S6: performing alignment and assembling; for example, the alignment cavities 1022/1012 and corresponding alignment pins 1011/1021 are connected correspondingly so that the two lens arrays 101, 102 are assembled along the optical axis 103;
S7: producing a lens module array 100 in which each optical axis 103 is aligned with one another;
S8: assembling and aligning other optical elements having a spacer 107 a circuit board 105, and image sensors 106 by glue in a stacked way sequentially; each image sensor 106 is aligned with each optical axis 103 of the lens module array 100;
S9: curing the glue: for example, a semifinished product in the step S8 is radiated by UV light so that the glue 104 is cured and a stacked lens module array 10 is formed.
S10: cutting straight lines through the stacked lens module array 10 to produce a plurality of rectangular stacked lens modules 11. As shown in FIG. 4, there are 16 (4×4) rectangular stacked lens modules 11 and each rectangular stacked lens module 11 consists of two lenses 101, 102 and the image sensor 106 connected on the circuit board 105. A stacked rectangular columnar lens module is produced.

As shown from FIG. 4 to FIG. 6, the rectangular stacked lens module having at least two glass lenses 101, 102 and other optical elements can be applied to optical systems. The optical elements include aperture, cover glasses, spacers, IR cut lenses, image sensors, optoelectronic semiconductor devices, circuit board, etc.

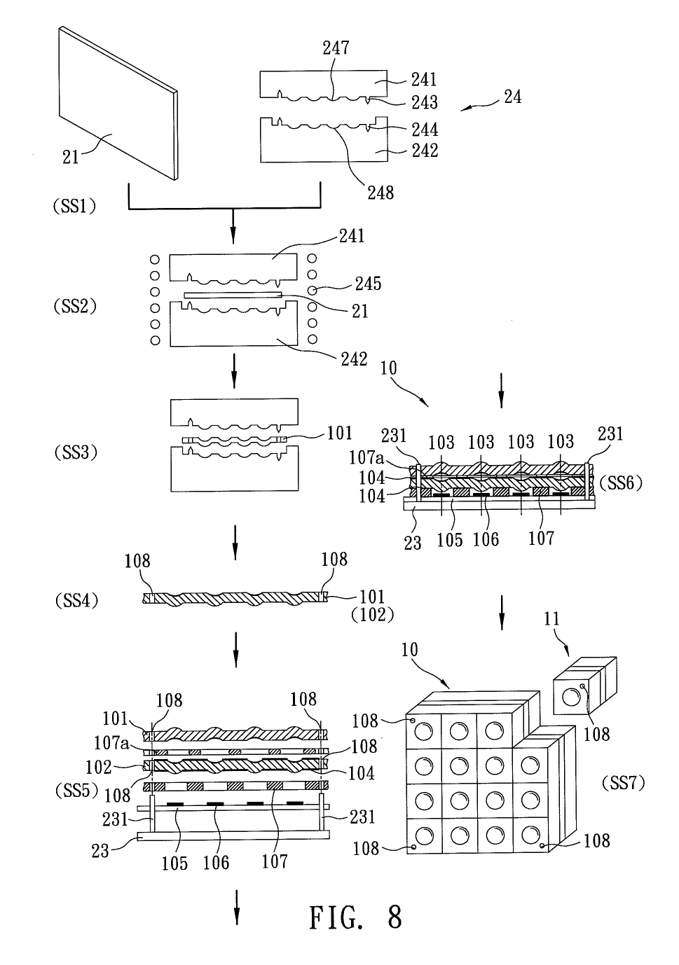

Refer to FIG. 8, a manufacturing method of a stacked lens module array 10 with through holes as alignment members includes following steps:

SS1: providing a rectangular sheet-like glass blank 21 and a molding mold 24 having an upper mold 221 and a lower mold 222 respectively disposed with a mold core of optical surfaces 247, 248 and a mold bar and/or mold sleeve for molding four through holes as alignment members;
SS2: setting the glass blank 21 into the mold 24, then heat the glass blank 21 by a heater 245 and apply pressure to run multi-cavity glass molding processes;
SS3: molding a first lens array 101;
SS4: producing at least another lens array 102 by repeating above steps; the lens arrays 101, 102 respectively include a plurality of lenses arranged in an array; through holes 108 for alignment are arranged on non-optical area of each lens array.
SS5: preparing a jig assembly 23 with at least one alignment rod 231 and optical elements having a circuit board 105 and a spacer 107; the circuit board 105 are preset with image sensors 106 and through holes corresponding to the through holes 108; then coating glue 104 on non-optical area of each component, setting these components 105, 107, 102, 101 on a jig assembly 23, and positioning each through hole 108 over the alignment rod 231 in turn; One more spacer 107a can be disposed between two adjacent lens arrays 101, 102 according to users' needs. Refer to FIG. 7, this embodiment is not disposed with the spacer 107a.
SS6: aligning the components by the alignment rod 231 of the jig assembly 23 and fixing them by glue 104; curing the glue 104 and releasing the jig assembly 23 so as to produce a stacked lens module array 10 in which each optical axis 103 is aligned.
SS7: making straight cuts through the stacked lens module array 10 to generate a plurality of rectangular stacked lens modules 11; each rectangular stacked lens module 11 includes at least two lenses 101, 102 and other optical elements 105, 106, 107 and aligned optical axes 103.

### Embodiment 1

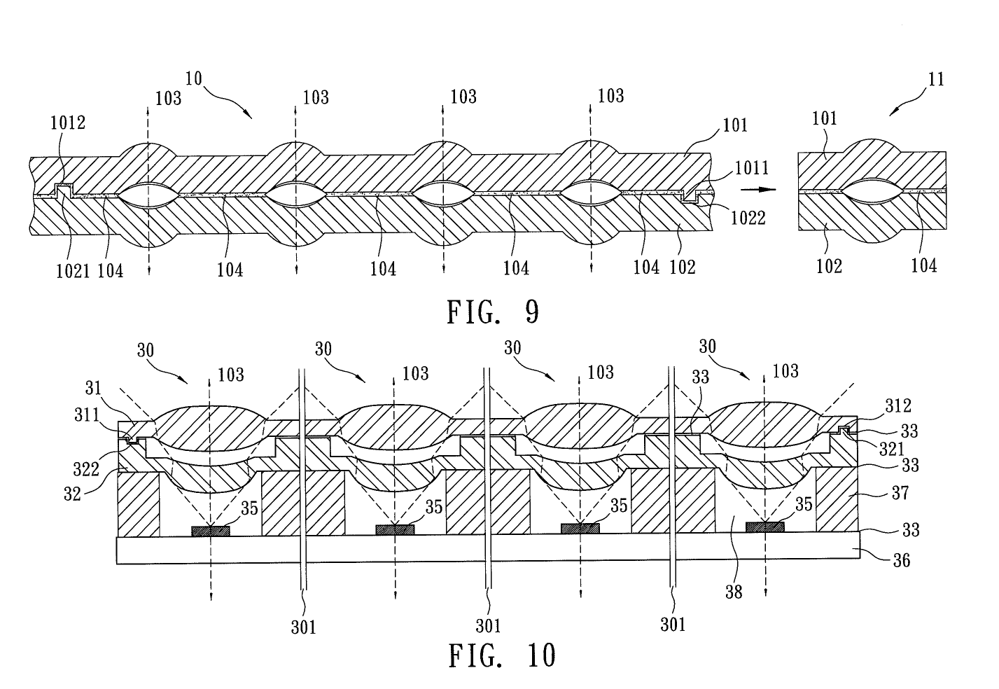

Refer to FIG. 9, an embodiment of a rectangular stacked lens module 11 including two optical glass lenses 101, 102 is produced by cutting of a stacked lens module array 10. The rectangular stacked lens module 11 generated through cutting of a center part of the stacked lens module array 10 is without alignment member such as columnar alignment pins 1011/1021 and corresponding alignment cavities 1022/1012. A lens module array 100 includes two lens arrays 101, 102 and four sets of alignment members. The alignment member sets consist of a plurality of columnar alignment pins 1011/1021 and corresponding alignment cavities 1022/1012. The four sets of alignment members are respectively disposed on four corners of the two lens arrays 101, 102. In FIG. 9, only two sets are revealed. After being aligned by four sets of alignment members, each optical axis 103 of the two lens arrays 101, 102 is aligned. Then UV curing glue 104 is applied to attach and fix the assembly. The alignment members (1011/1021, 1022/1012) and each lens array 101. 102 are molded by multi-cavity molds 22 once at a time. Thus each alignment member and each optical axis 103 are fixed. Therefore, after being assembled by the alignment members, each optical axis 103 of the two lens arrays 101, 102 are assembled according to a preset tolerance so as to achieve precise assembling.

### Embodiment 2

Refer to FIG. 7, an embodiment of a rectangular stacked lens module 11 is generated by making straight cutting through a stacked lens module array 10. The stacked lens module array 10 consists of two lens arrays (the first array and the second lens array), four sets of alignment members, a circuit board (the first optical element) 105, a plurality of image sensors (the second optical element) 106, and a plurality of spacers (the third optical element) 107. The four sets of alignment members are four sets of through holes 108. There are only two sets of through holes 108 shown in FIG. 7. The image sensor 106 is corresponding to the optical area (lens) and is preset on the circuit board 105. The circuit board 105 is aligned with the second lens array 102 at a preset interval (by the spacer 107) and is aligned with the first lens array 101 by the through holes 108. After alignment of each optical axis 103 of the lens arrays 101, 102 with each image sensor 106, glue 104 is applied to adhere and fix the assembly of the lens module.

### Embodiment 3

Refer to FIG. 10, this embodiment of a rectangular stacked lens module 30 is applied to an LED assembly. In an LED assembly, in order to concentrate light from LED chips 35 by optical glass lenses and project light to objectives with a preset distribution pattern, a plurality of optical glass lenses are stacked and spaced at a preset interval. In this embodiment, the rectangular stacked lens module 30 is composed of a first optical glass lens 31, a second optical glass lens 32, a circuit board 36, a LED chip 35, spacers 37 and a silicon layer 38. The optical axes 103 of the two lenses 31, 32 are aligned and there is a certain distance between the two lenses 31, 32. In this embodiment, along the optical axis 103, the distance between a convex surface of the first lens 31 on the light source side and a concave surface of the second lens 32 on the object side is 0.65 mm. The distance between an image side convex surface of the second lens 32 and the LED chip 35 is 3.1 mm. The silicon layer 38 used as a wave length transmission layer is filled between the second lens 32 and the LED chip 35. In FIG. 10, there are only one alignment pin 311/321 and one alignment cavity 312/322 shown in the two lens arrays 31, 32. The manufacturing method of this embodiment is similar to that of the above embodiment. The lens module 30 is formed by cutting through dicing lines 301 and is used in LED assemblies.

### Embodiment 4

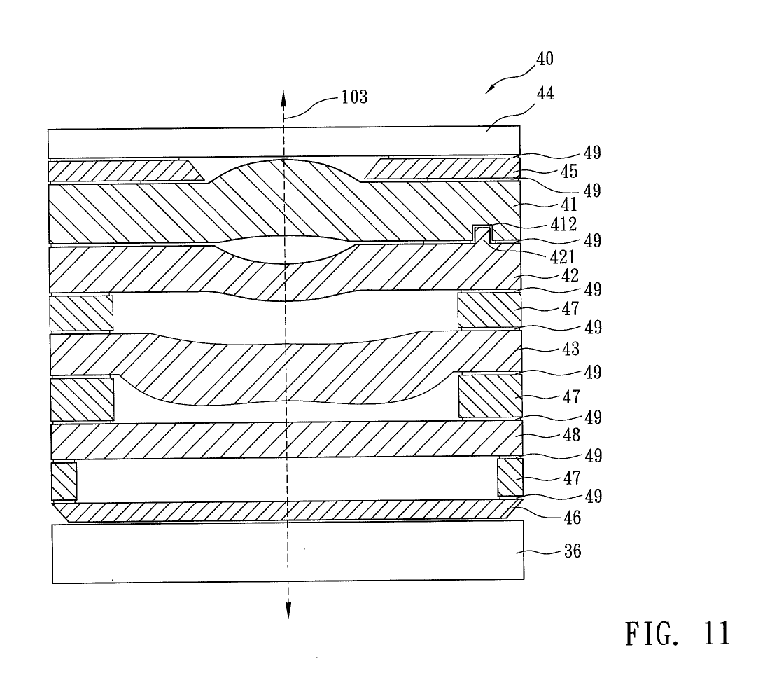

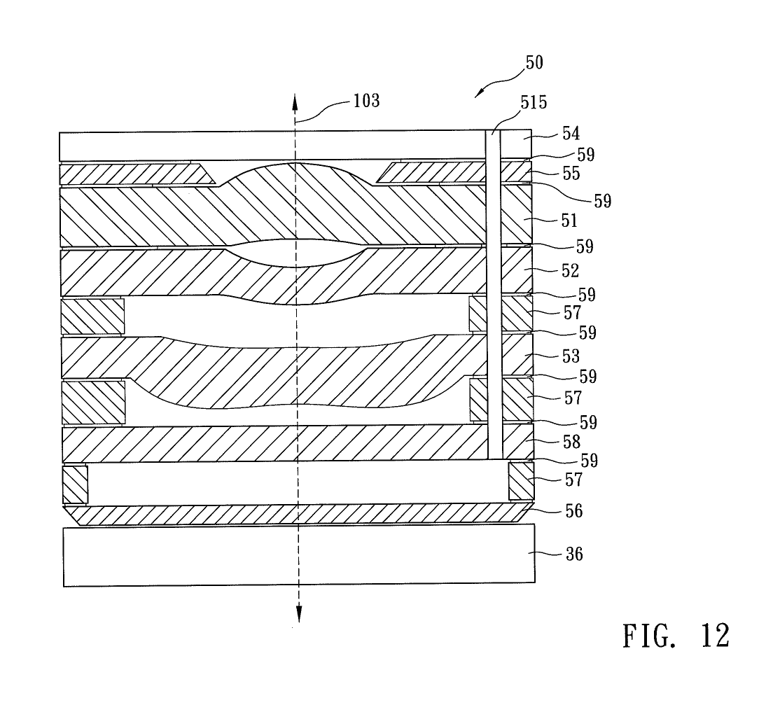

Refer to FIG. 11, this embodiment of a rectangular stacked lens module 40 is applied to mobile camera lenses. From the object side to the image side, the lens module 40 includes a first lens 41 that is a meniscus lens with a concave surface facing the image side, a second lens 42 that is a meniscus lens with a convex surface facing the image side, and a third lens 43 that is a M-shaped lens with optical elements. The optical elements consists of a cover glass 44, an aperture 45, three spacers 47, an IR cut lens 48, an image sensor 46 and a circuit board 36.

In the following list one, the number of the optical surfaces from the object side in turn, the optical surface type, the radius of curvature R (mm) of each optical surface on the optical axis, the on-axis surface spacing and lens materials.

List one optical parameters of the embodiment 4 applied to mobile camera lenses:

| | | | radius of | on-axis | |
|---|---|---|---|---|---|
| | | | curvature R | surface | |
| Surf# | | optical surface type | (mm) | spacing | lens materials |
| 1. | (STO) aperture and | aspheric surface | 1.0613 | 0.625417 | SCHOTT_BAC2 |
| | first optical lens | | | | |
| 2. | concave surface of the | aspheric surface | 2.8968 | 0.333 | |
| | first optical lens | | | | |
| 3. | concave surface of the | aspheric surface | −1.2031 | 0.3 | OHARA_FTM16 |
| | second optical lens | | | | |
| 4. | convex surface of the | aspheric surface | −1.4586 | 0.71 | |
| | second optical lens | | | | |
| 5. | object side of the third | aspheric surface | 7.6865 | 0.635 | SCHOTT_BAC2 |
| | optical lens | | | | |
| 6. | image side of the third | aspheric surface. | 3.4879 | 0.3 | |
| | optical lens | | | | |
| 7. | object side of the IR | | ∞ | 0.3 | BK7 |
| | cut lens | | | | |
| 8. | image side of the IR | | ∞ | 0.6895 | |
| | cut lens | | | | |
| 9. | sensing surface of the | | ∞ | | |
| | image sensor | | | | |

The manufacturing processes of this embodiment are similar to that of the embodiment 3, first produce a glass lens module array having 16 first lenses and 16 second lenses. The number of the lenses is not limited to 16. The non-optical area of each lens array is disposed with alignment member such as an alignment cavity 412 on the first lens 41 and an alignment pin 421 on the second lens 42 so as to align optical axes 103 of each lens. Then produce a lens array having 16 (4×4) third lenses 43 by glass molding. Also produce optical element plate having 16 (4×4) apertures 45 and 16 (4×4) spacers 47. Weld 16 (4×4) optical sensors 46 on preset positions of a circuit board 36. Next use glue 49 such as UV curing glue to bind each optical element plate 45, 47, a cover glass 4, an IR cut lens 48, a lens module array formed by the first lens array 41 and the second lens array 42, with the third lens array 43 in a stacked way. After being radiated in an UV oven, a stacked lens module array with 16 camera lenses is formed and 16 rectangular stacked lens modules 40 are generated through cutting. By this method, the manufacturing processes are simplified, the cost is reduced and predetermined optical functions are achieved.

### Embodiment 5

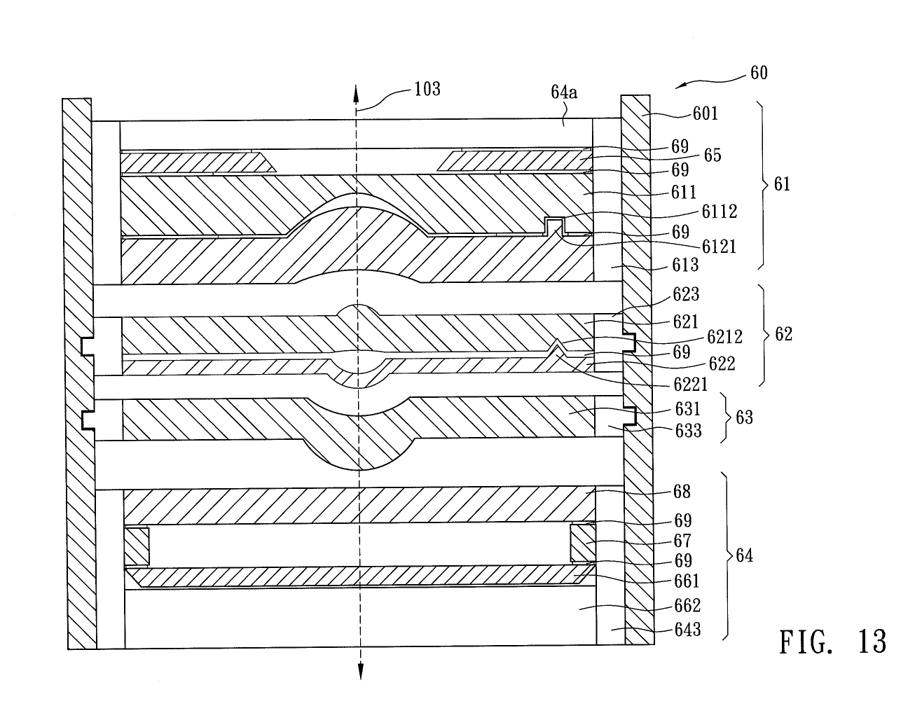

Refer to FIG. 12, this embodiment of a rectangular stacked lens module 50 is applied to mobile camera lens, similar to the above embodiment. At least one through hole 515 is used as an alignment member, as the through hole 108 in FIG. 7 (the second embodiment). The alignment members 412, 421 of the embodiment four in FIG. 11 are replaced by through holes. The manufacturing method of this embodiment is similar to that of the above embodiment. An optical glass lens array respectively having 16 (4×4) first lenses 51, second lenses 52 and third lenses 53 is produced. A through hole 515 is arranged at non-optical area of each corner of each lens array and there are four through holes 515 totally used as alignment members. Then produce an optical element plate having 16 (4×4) apertures 55 and an optical element plate having 16 (4×4) spacers 57, both disposed with through holes 515 on corresponding positions. That means each optical element plate includes four through holes 515. In FIG. 12, only one through hole 515 is shown. 16 (4×4) optical sensors 56 are welded on preset positions of the circuit board 36. While assembling, use a jig assembly 23 (as shown in FIG. 7) having an alignment rod 231 disposed on each of four corners thereof and through holes of above optical element plates and of each lens array are positioned over the alignment rod correspondingly. Then bind each optical element plate 55, 57, a cover glass 54, an IR cut lens 58, the circuit board 36 and the lens arrays in a stacked way sequentially by glue. After curing of the glue, release the jig assembly and a stacked lens module array with 16 camera lenses is produced. 16 rectangular stacked lens module 50 are generated through cutting. By this method, 16 camera lenses are produced once and optical axes of the first lens 51, the second lens 52 and the third lens 53 of each camera lens are aligned. There is a preset distance between the lens and each optical elements. Thus the manufacturing processes are simplified, the cost is down and the predetermined optical functions are achieved.

### Embodiment 6

Refer to FIG. 13, this embodiment of a rectangular stacked lens module 60 applied to camera zoom lenses includes a first optical group 61, a second optical group 62, a third optical group 63, and a fourth optical group 64. Each optical group 61-64 is a rectangular stacked lens module produced according to the manufacturing method of the present invention and is assembled with a lens holder 613, 623, 633, 643 and then is mounted in a lens barrel 601 so as to form a zoom lens. The first optical group 61 and the fourth optical group 64 are fixed on the lens barrel 601, remaining static while zooming while the second optical group 62 and the third optical group 63 are mounted into sliding slots (not shown in figure) and moving upward and downward along the optical axis while zooming so as to achieve the purpose of zooming.

The first optical group 61 consists of a cover glass 64a, an aperture 65, a first lens 611, a second lens 612 and the lens holder 613. The first lens 611 and the second lens 612 are made of optical glass and disposed with alignment members such as an alignment cavity 6112 and corresponding alignment pin 6121. The manufacturing processes of this embodiment are similar to those of the embodiment 4. Firstly, a stacked lens module array having a cover glass 64a, an aperture 65, a first lens 611, and a second lens 612 glued with one another by glue 69 is produced. Then the array is cut through straight lines into a plurality of rectangular stacked lens module. Each lens module is positioned into a lens holder 613. The lens holder 613 is designed into a column with a rectangular hole therein so as to assemble with the columnar lens barrel 601. Thus the rectangular stacked lens module is mounted into the rectangular hole to be assembled with the lens holder 613.

The second optical group 62 consists of a third lens 621, a fourth lens 622 and the lens holder 623. The third lens 621 and the fourth lens 622 are made of optical glass and disposed with alignment members such as an alignment cavity 6212 and corresponding alignment pin 6221. The manufacturing processes of this embodiment are similar to those of the first optical group 61. The lens holder 623 in this embodiment is similar to the lens holder 613, a column with a rectangular hole therein.

The third optical group 63 includes a fifth lens 631 made of optical plastic and a lens holder 633 that is a column with a hole for mounting the fifth lens 631.

The fourth optical group 64 includes an IR cut lens 68, a spacer 67, an image sensor 661, a circuit board 662 and a lens holder 643. The lens holder 643 is designed into a column with a hole for mounting each optical element in the fourth optical group 64.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A rectangular stacked lens module formed by cutting of a stacked lens module array, comprising:
at least two optical glass lenses whose optical axes being aligned with each other; and
a plurality of optical elements spaced at a preset interval and glued with the two optical glass lenses in a stacked way, an optical axis of each optical element being aligned with one another;
wherein the stacked lens module array comprises at least two optical glass lens arrays, each optical glass lens array comprises a plurality of optical glass lenses arranged in an array and formed by multi-cavity and alignment members disposed on a periphery of non-optical area of the optical glass lens array, the alignment members of the two adjacent optical glass lens arrays correspond so that the optical axis of each optical glass lens of the two adjacent optical glass lens arrays is aligned with each other, and the two optical glass lens arrays and a plurality of optical elements are spaced at a preset interval, stacked and glued with one another.

2. The rectangular stacked lens module as claimed in claim 1, wherein the alignment members of the two adjacent optical glass lens arrays comprises at least one alignment pin and at least one alignment cavity corresponding to the alignment pin.

3. The rectangular stacked lens module as claimed in claim 2, wherein the alignment pin is columnar or conical while the alignment cavity is a receiving cavity in a shape corresponding to the alignment pin.

4. The rectangular stacked lens module as claimed in claim 1, wherein the alignment members of the two adjacent optical glass lens arrays are through holes so that the optical axes of the two adjacent optical glass lenses are aligned by positioning the through holes over a alignment rod of a jig assembly.

5. The rectangular stacked lens module as claimed in claim 4, wherein the module further comprises a spacer arranged and fixed between the two adjacent optical glass lens arrays by glue so as to produce a preset interval of air.

6. The rectangular stacked lens module as claimed in claim 1, wherein optical elements are selected from shades, spacers, apertures, cover glass, IR cut lenses, image sensors, optoelectronic semiconductor devices or their combinations.

7. A manufacturing method of a rectangular stacked lens module, comprising steps of:
providing a glass blank and optical elements;
providing an upper mold and a lower mold for molding optical glass lens arrays while the upper mold and the lower mold respectively are disposed with a plurality of mold cores for forming a plurality of optical glass lenses and a mold pin and/or mold bushing for forming alignment members;
placing the glass blank between the upper mold and the lower mold, then heating and applying pressure to the glass blank for running multi-cavity glass molding processes;
molding an optical glass lens array having a plurality of optical glass lenses arranged in an array and alignment members on non-optical area;
producing at least another optical glass lens array having alignment members on non-optical area, and the alignment members corresponding to the alignment members of the above optical glass lens array according to the above steps;
coating glue on non-optical area between two adjacent optical glass lens arrays;
aligning the alignment members of the two adjacent optical glass lens arrays to produce an optical glass lens array by assembling;
assembling with the optical elements in a stacked way sequentially by glue;
curing the glue to form a stacked lens module array; and
cutting straight lines through the stacked lens module array to get a plurality of rectangular stacked lens modules.

8. The method as claimed in claim 7, wherein the optical elements are disposed with alignment members corresponding to each other so that the optical elements are assembled and integrated with the optical glass lens arrays by glue in a stacked way.

9. A manufacturing method of a rectangular stacked lens module with at least one through hole, comprising steps of:
providing a glass blank and optical element;
providing an upper mold and a lower mold for molding optical glass lens arrays while the upper mold and the lower mold respectively are disposed with a plurality of mold cores for forming a plurality of optical glass lenses and a mold bar and/or mold sleeve for molding through-hole type alignment members;
placing the glass blank between the upper mold and the lower mold, then heating and applying pressure to the glass blank for performing multi-cavity glass molding processes;
molding an optical glass lens array having a plurality of optical glass lenses arranged in an array and through holes as alignment members disposed on non-optical area;
producing at least another optical glass lens array having through holes on non-optical area, corresponding to the above through holes and used as alignment members;
preparing a jig assembly with at least one alignment rod, mounting the at least two optical glass lenses and the optical element into the jig assembly and positioning the through holes over the alignment rod for alignment;
coating glue on non-optical area of each optical glass lens array for stacking and assembling;
aligning by the alignment rod of the jig assembly and fixing by the glue so as to form a stacked lens module array in a stacked way;
curing the glue and releasing the jig assembly so as to produce a stacked lens module array; and
cutting straight lines through the tacked lens module array to get a plurality of rectangular stacked lens modules.

10. The method as claimed in claim 9, wherein a spacer is arranged between the non-optical area of two adjacent optical glass lens arrays and is assembled and integrated with the two adjacent optical glass lens arrays by glue.

11. The method as claimed in claim 9, wherein the optical element is disposed with at least one corresponding through hole so that the optical element is aligned by the alignment rod of the jig assembly to be stacked and assembled.
